(19) United States
(12) Patent Application Publication
(10) Pub. No.: US 2025/0014001 A1
(43) Pub. Date: Jan. 9, 2025

(54) APPARATUS AND METHOD FOR PROVIDING SERVICE USING JOINTLY OWNED VIRTUAL ACCOUNT

(71) Applicant: ENIGMA CO., LTD., Seongnam-si (KR)

(72) Inventor: Hyun Jin LIM, Seoul (KR)

(21) Appl. No.: 18/264,359

(22) PCT Filed: Jun. 15, 2023
(86) PCT No.: PCT/KR2023/008293

§ 371 Date: Aug. 4, 2023

(30) Foreign Application Priority Data
Jun. 16, 2022 (KR) 10-2022-0073293

(51) Int. Cl. G06Q 20/10; G06Q 20/40

(52) U.S. Cl. CPC G06Q 20/108; G06Q 20/4014

(57) ABSTRACT

A service providing apparatus according to an exemplary embodiment of the present disclosure includes a communication unit which receives a service performance request which requests the performance of a service performed using a virtual account which is jointly owned by a plurality of holders; a processor which calculates a first amount which is applied to the virtual account in response to the performance of the service and a second amount which is applied to an actual account which is linked to the virtual account based on an ownership ratio of each of the plurality of holders and is individually owned by the plurality of holders, and the processor performs the service by applying the second amount corresponding to the actual account to the actual account.

### TECHNICAL FIELD

The present disclosure relates to an apparatus and a method for providing a service using a jointly owned virtual account, and more particularly, to an apparatus and a method for providing a service using a virtual account which is jointly owned by a plurality of holders.

### BACKGROUND ART

A joint account is an account that is jointly managed by two or more joint administrators and is managed by joint administrators who are natural person or corporate body. The joint administrates need to share the same account due to various reasons, but it is not possible for one of the joint administrates to acquire full authority (for example, transfers and withdrawals) for the account due to the security or reliability reasons.

Some authorities for the joint account require the consent of all joint administrates so that a bank which offers the joint account generally requires the consent of all the joint administrates to process the service to be certified.

In addition, since each account that can be operated through a network in the related art has only one holder, there is a problem that multiple holders cannot jointly hold one joint account.

### DISCLOSURE

### Technical Problem

An object to be achieved by the present disclosure is to provide a service providing apparatus and a service providing method which provide a service using a jointly owned virtual account by linking a virtual account which can be jointly owned by a plurality of holders and actual accounts of the plurality of holders.

Technical problems of the present invention are not limited to the above-mentioned technical problems, and other technical problems, which are not mentioned above, can be clearly understood by those skilled in the art from the following descriptions.

### Technical Solution

In order to achieve the above-described object, according to an aspect of the present disclosure, a service providing apparatus includes a communication unit which receives a service performance request which requests the performance of a service performed using a virtual account which is jointly owned by a plurality of holders; a processor which calculates a first amount which is applied to the virtual account in response to the performance of the service and a second amount which is applied to an actual account which is linked to the virtual account based on an ownership ratio of each of the plurality of holders and is individually owned by the plurality of holders.

Desirably, the processor performs the service by applying the second amount corresponding to the actual account to the actual account.

Desirably, the processor generates the virtual account based on account information of the actual account and ownership ratio information of each of the plurality of holders.

Desirably, the processor calculates the second amount by applying the ownership ratio to the first amount.

Desirably, the processor determines whether a service performance condition is satisfied, based on a digital signature value received from a terminal of each of the plurality of holders, a secret key received from the terminal of each of the plurality of holders, and a consent message which is received from the terminal of each of the plurality of holders and indicates whether the holder consents to perform the service.

Desirably, when it is determined that the service performance condition is satisfied, the processor performs the service by calculating the second amount.

Desirably, the processor determines whether a first service performance condition is satisfied based on a verification result of the digital signature value, determines whether a second service performance condition is satisfied based on a verification result of the secret key, and determines whether a third service performance condition is satisfied based on the consent message.

Desirably, the processor calculates an amount difference between a balance of the actual account and the second amount, classifies an actual account whose amount difference is calculated to be less than a reference amount as a deficient account, and when one or more actual accounts are classified as the deficient accounts, does not perform the service.

Desirably, the processor calculates an amount difference between a balance of the actual account and the second amount, classifies an actual account whose amount difference is calculated to be less than a reference amount as a deficient account, classifies an actual account whose amount difference is calculated to be equal to or larger than a reference amount as a sufficient account, adds amount differences which are less than the reference amount, among the amount differences, to be calculated as a deficient amount, applies the ownership ratio of a holder of the sufficient account to the deficient amount to calculate a third amount, and applies a third amount corresponding to the sufficient account to the sufficient account to perform the service.

Desirably, the processor calculates an amount difference between a balance of the actual account and the second amount, classifies an actual account whose amount difference is calculated to be less than a reference amount as a deficient account, classifies an actual account whose amount difference is calculated to be equal to or larger than a reference amount as a sufficient account, adds amount differences which are less than the reference amount, among the amount differences, to be calculated as a deficient amount, applies the ownership ratio of a holder of the sufficient account to the deficient amount to calculate a third amount, and requests a holder of the sufficient account for the consent to apply the third amount to the sufficient account and when the consent messages are received from the holders of all the sufficient accounts, applies the third amount corresponding to the sufficient account to the sufficient account to perform the service.

Desirably, when an amount which is equal to or larger than the amount difference is deposited to an actual account classified as the deficient account, the processor transmits the third amount from an actual account classified as the deficient account to an actual account classified as the sufficient account.

Desirably, the processor determines whether the simplified approval condition is satisfied based on one or more of whether the first amount is less than a small amount and whether a consent message received from a terminal of a holder set as a simple approver among the plurality of holders indicates consent to performance of the service and when it is determined that the simple approval condition is satisfied, the processor performs the service by calculating the second amount even though the service performance condition is not satisfied.

Desirably, the processor changes the ownership ratio based on a pros/cons message indicating approval/disapproval of the holder about the change of the ownership ratio.

In order to achieve the above-described object, according to another aspect of the present disclosure, a service providing method includes receiving a service performance request which requests the performance of a service performed using a virtual account which is jointly owned by a plurality of holders, by a communication unit; calculating a first amount which is applied to the virtual account in response to the performance of the service and a second amount which is applied to an actual account which is linked to the virtual account based on a relative ratio between ownership ratios of the plurality of holders and is individually owned by the plurality of holders by a processor; and performing the service by applying the second amount corresponding to the actual account to the actual account, by the processor.

In order to achieve the above-described object, according to another aspect of the present invention, a computer program is combined with a computer which is hardware to be stored in a computer readable recording medium to perform the service providing method.

Other detailed matters of the embodiments are included in the detailed description and the drawings.

### Advantageous Effects

According to the service providing apparatus and the service providing method according to the disclosed exemplary embodiment, under the conventional financial system in which an account can be owned by only one holder, various services can be provided through a jointly owned virtual account by allowing a plurality of holders to jointly own one virtual account.

The effects of the present disclosure are not limited to the technical effects mentioned above, and other effects which are not mentioned can be clearly understood by those skilled in the art from the following description.

### DESCRIPTION OF DRAWINGS

FIG. 1 is an exemplary diagram of a service providing system including a service providing apparatus using a jointly owned virtual account according to an exemplary embodiment of the present disclosure;

FIG. 2 is a view for explaining a virtual account used by a service providing apparatus using a jointly owned virtual account according to an exemplary embodiment of the present disclosure;

FIG. 3 is a flowchart illustrating a service providing method using a jointly owned virtual account according to an exemplary embodiment of the present disclosure;

FIG. 4 is a flowchart illustrating a service providing method using a jointly owned virtual account according to another exemplary embodiment of the present disclosure;

FIG. 5 is a flowchart illustrating a service providing method using a jointly owned virtual account according to still another exemplary embodiment of the present disclosure;

FIG. 6 is a flowchart illustrating a service providing method using a jointly owned virtual account according to still another exemplary embodiment of the present disclosure; and

FIG. 7 is a block diagram illustrating a configuration of a service providing apparatus according to an exemplary embodiment of the present disclosure in detail.

### MODE FOR CARRYING OUT THE DISCLOSURE

Advantages and characteristics of the present disclosure and a method of achieving the advantages and characteristics will be clear by referring to exemplary embodiments described below in detail together with the accompanying drawings. However, the present disclosure is not limited to exemplary embodiments disclosed herein but will be implemented in various different forms. The exemplary embodiments are provided by way of example only so that a person of ordinary skilled in the art can fully understand the disclosures of the present invention and the scope of the present invention. Therefore, the present disclosure will be defined only by the scope of the appended claims.

The terms used in the present specification are for explaining the embodiments rather than limiting the present invention. Unless particularly stated otherwise in the present specification, a singular form also includes a plural form. The term “comprise” and/or “comprising” used in the specification does not exclude the presence or addition of one or more other components in addition to the mentioned component. Like reference numerals generally denote like elements throughout the specification and “and/or” includes each of mentioned components and all combinations of one or more components. Although the terms “first”, “second”, and the like are used for describing various components, these components are not confined by these terms. These terms are merely used for distinguishing one component from the other components. Therefore, a first component to be mentioned below may be a second component in a technical spirit of the present invention.

Unless otherwise defined, all terms (including technical and scientific terms) used in the present specification may be used as the meaning which may be commonly understood by the person with ordinary skill in the art, to which the present invention belongs. It will be further understood that terms defined in commonly used dictionaries should not be interpreted in an idealized or excessive sense unless expressly and specifically defined.

The term “˜unit” or “˜module” used in the specification refers to a hardware component such as FPGA or ASIC and the “unit” or “module” performs some functions. However, “˜unit” or “˜module” is not limited to the software or the hardware. “˜unit” or “˜module” may be configured to be in an addressable storage medium or may be configured to reproduce one or more processors. Accordingly, as an example, “˜unit” or “˜module” includes components such as software components, object oriented software components, class components, and task components, processes, functions, attributes, procedures, subroutines, segments of a program code, drivers, a firmware, a microcode, a circuit, data, database, data structures, tables, arrays, and variables. A function which is provided in the components and “˜units” or “˜modules” may be combined with a smaller number of components and “˜units” or “˜modules” or divided into additional components and “˜units” or “˜modules”.

Spatially relative terms such as “below”, “beneath”, “lower”, “above”, or “upper” may be used to easily describe the correlation between one component and other components as illustrated in the drawings. The spatially relative terms should be understood to include different directions of the elements when the elements are used or operated in addition to the direction illustrated in the drawings. For example, when the component illustrated in the drawing is turned over, a component which is disposed below or beneath other component may be disposed above other component. Accordingly, the exemplarily term “below” or “beneath” may include both downward and upward directions. The components may be oriented in different directions so that terms which are spatially relative may be interpreted according to the orientation.

In the present disclosure, a terminal or a device refers to all types of hardware device including at least one processor and depending on the exemplary embodiment, is understood to include a software configuration which operates in the corresponding hardware device. For example, the terminal or the device is understood to include all smartphones, tablet PCs, desktops, notebooks, servers and user clients and applications run in each device, but is not limited thereto.

Digital signature value verification used in the present disclosure may be used interchangeably with the same or similar meaning as authentication.

Hereinafter, exemplary embodiments of the present disclosure will be described in detail with reference to the accompanying drawings.

Steps described in the present disclosure are described to be performed by a smart phone or a server, but a subject of each step is not limited thereto and at least some of the steps may be performed in different devices according to the embodiments.

Further, a service provided by the service providing apparatus according to the present disclosure may be provided not only through a mobile application, but also a web page.

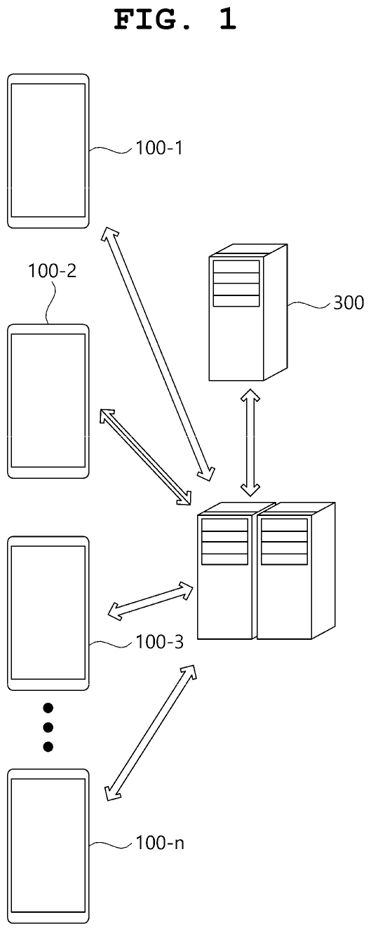

FIG. 1 is an exemplary diagram of a service providing system including a service providing apparatus using a jointly owned virtual account according to an exemplary embodiment of the present disclosure.

Referring to FIG. 1, a service providing system includes a service providing apparatus 200, a plurality of terminals 100-1 to 100-n, and a public key verification server 300.

The plurality of terminals 100-1 to 100-n may be terminals controlled by a plurality of holders which jointly owns a virtual account.

Here, even though the plurality of terminals 100-1 to 100-n may be n terminals (n is a natural number), for the convenience of description, in the present disclosure, an example that a plurality of terminals is three terminals will be described. Further, in the present disclosure, it is assumed that the plurality of terminals is three terminals, so that it is also assumed that the number of holders is three.

When the service providing apparatus 200 receives a service request from any one of the plurality of terminals 100-1 to 100-3, the service providing apparatus determines whether a service performance condition is satisfied. If the service performance condition is satisfied, the service providing apparatus performs the requested service.

Specifically, when the service performance condition is satisfied, the service providing apparatus 200 calculates a first amount applied to a virtual account in response to the service performance and a second amount applied to an actual account which is linked to a virtual account based on an ownership ratio of each of the plurality of holders with respect to the virtual account and is independently owned by each of the plurality of holders.

Next, the service providing apparatus 200 applies the second amount corresponding to each actual account to the actual account to perform the service.

A service described in the present disclosure includes various services. As an exemplary embodiment, the service according to the present disclosure may be a banking service in which one virtual account is used by a plurality of holders.

That is, the service performance request may be a request of a banking service by which a second amount is transferred from each actual account owned by each of the plurality of holders.

Such a service providing apparatus 200 includes a communication unit, a memory, and a processor.

The communication unit may receive a service performance request which requests the performance of the service performed using a virtual account which is jointly owned by the plurality of holders.

At this time, the communication unit receives the service performance request from any one terminal of the plurality of terminals 100-1 to 100-3.

The processor may further include a random access memory (RAM, not illustrated) and a read-only memory (ROM, not illustrated) which transitorily and/or permanently stores a signal (or data) processed in the processor. Further, the processor may be implemented in the form of a system on chip (SoC) including at least one of a graphic processor, an RAM, and a ROM. In the memory, programs (one or more instructions) for processing and controlling the processor may be stored. Programs stored in the memory may be divided into a plurality of modules depending on the functions.

At this time, the memory may store information about a virtual account and information about a plurality of holders which jointly owns the virtual account.

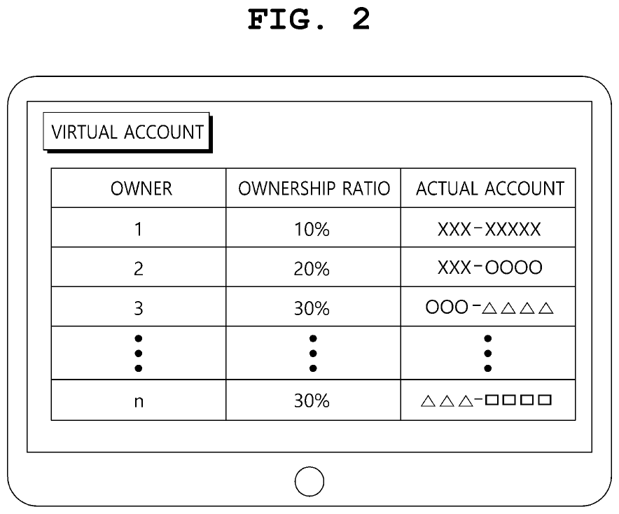

FIG. 2 is a view for explaining a virtual account used by a service providing apparatus using a jointly owned virtual account according to an exemplary embodiment of the present disclosure.

Further referring to FIG. 2, the virtual account used by the service providing apparatus 200 according to the present disclosure may be jointly owned by a plurality of holders 1 to n.

At this time, ownership of the virtual account can be divided according to the ownership ratio of each of the plurality of holders 1 to n.

Further, the actual account of each of the plurality of holders 1 to n may be linked to the virtual account.

The virtual account is not an account issued by the financial institution and may be information in which the ownership ratio of each of the plurality of holders 1 to n and an actual account of each of the plurality of holders 1 to n which is linked to the virtual account are defined.

The virtual account may be generated by the processor of the service providing apparatus 200 based on account information of the actual account and the ownership ratio information of each of the plurality of holders.

In the meantime, the actual account of each of the plurality of holders 1 to n may be an account which is solely owned by each of the plurality of holders 1 to n and is issued by the financial institution.

In the meantime, the virtual account may be a virtual account which may be a subject receiving the service.

In the meantime, the virtual account according to another exemplary embodiment may be a virtual account. When the virtual account is a virtual account, the virtual account is linked to an actual account of each of the plurality of holders 1 to n and an ownership ratio for the virtual account of the plurality of holders 1 to n may be defined.

Further, when the virtual account is a virtual account, the service according to the present disclosure may be a service which makes the payment through a virtual account.

For example, the service which makes the payment through the virtual account may be a service which pays Internet contents (E-book, or video contents).

Here, the account may be an account which is used for platforms (for example, Netflix) which provide the Internet contents as paid services and the service providing apparatus 200 may be a server which operates the platform.

That is, the virtual account is a virtual account and the actual account of each of the plurality of holders 1 to n is an actual account, the service performance request may be a request for allowing the actual account of the plurality of holders to use the paid service of the above-described platform. A cost of using the requested paid service is divided by an ownership ratio for the virtual account of the plurality of holders 1 to n to be charged to the actual account of the holders 1 to n.

Further, when it is difficult to simultaneously use the paid service provided by the platform, a usage time of the pain service may be divided by the ownership ratio for the virtual account of the plurality of holders 1 to n and may be allocated to the actual account of the holders 1 to n.

In the meantime, in the above description, it is described that the virtual account which is jointly owned by the plurality of holders 1 to n is linked to the actual account of the plurality of holders 1 ton. However, the jointly owned virtual account may be linked to a virtual account which is solely owned by a holder, instead of the actual account and the actual account which is solely owned by the holder is linked to the virtual account which is solely owned by a holder.

For example, when the plurality of holders includes a first holder, a second holder, and a third holder, virtual accounts which are independently owned by the first holder, the second holder, and the third holder are a first virtual account, a second virtual account, and a third virtual account, and actual accounts which are independently owned by the first holder, the second holder, and the third holder are a first actual account, a second actual account, and a third actual account, the first virtual account, the second virtual account, and the third virtual account are linked to the virtual account which is jointly owned by the first holder, the second holder, and the third holder and the first actual account, the second actual account, and the third actual account are linked to the first virtual account, the second virtual account, and the third virtual account.

At this time, a number of accounts which are linked to the virtual account which is jointly owned by the first holder, the second holder, and the third holder, among the first virtual account, the second virtual account, and the third virtual account, may be one or more and the actual account may be linked, instead of an account, among the first virtual account, the second virtual account, and the third virtual account, which is not linked to the virtual account jointly owned by the first holder, the second holder, and the third holder.

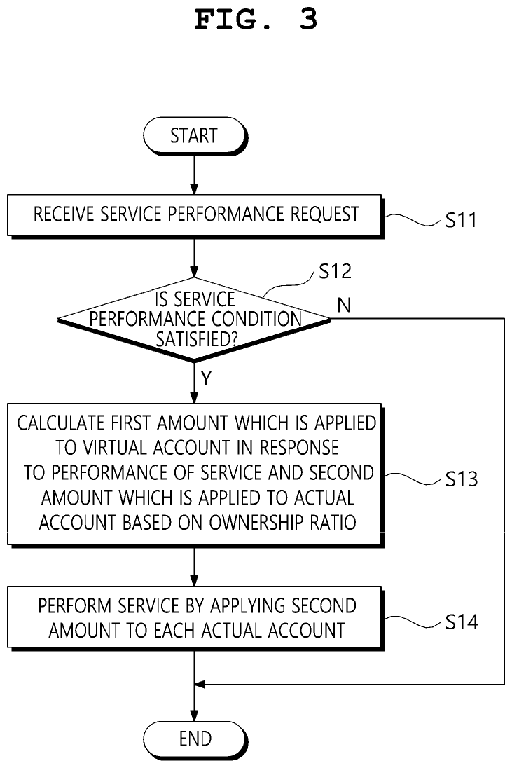

For example, when the first virtual account and the second virtual account are linked to the virtual account jointly owned by the first holder, the second holder, and the third holder, but the third virtual account is not linked, if the third actual account is linked, instead of the third virtual account, the first actual account and the second actual account may be linked to the first virtual account and the second virtual account. FIG. 3 is a flowchart illustrating a service providing method using a jointly owned virtual account according to an exemplary embodiment of the present disclosure.

Referring to FIG. 3, the communication unit of the service providing apparatus 200 receives a service performance request which requests the performance of the service using a virtual account which is jointly owned by the plurality of holders (S11). Next, a processor of the service providing apparatus 200 may determine whether a service performance condition is currently satisfied (S12).

To this end, the processor of the service providing apparatus 200 determines whether the service performance condition is satisfied, based on a digital signature value received from a plurality of terminals 100-1 to 100-3, a secret key received from the plurality of terminals 100-1 to 100-3, and a consent message which is received from the plurality of terminals 100-1 to 100-3 and indicates whether the holder consents to the performance of the service.

When all digital signature values received from the plurality of terminals 100-1 to 100-3 are verified, the processor of the service providing apparatus 200 according to the exemplary embodiment determines that a first service performance condition is satisfied. When all the secret keys received from the plurality of terminals 100-1 to 100-3 are verified, the processor determines that a second service performance condition is satisfied. Further, all the content messages received from the plurality of terminals 100-1 to 100-3 indicate the consent to the service performance, the processor determines that a third service performance condition is satisfied.

When it is determined that all the first to third service performance conditions are satisfied, the processor of the service providing apparatus 200 performs the requested service through the service performance request.

To this end, the service providing apparatus 200 may store three different secret keys which is the same number as the number of the plurality of terminals. The service providing apparatus 200 transmits three different secret keys to three terminals 100-1, 100-2, and 100-3, respectively.

In the meantime, the plurality of terminals 100-1 to 100-3 may store a private key required for authentication, a public key corresponding to the private key, and a secret key received from the service providing apparatus 200. For the convenience of description, it is assumed that the first terminal 100-1 stores a first private key, a first public key, and a first secret key, the second terminal 100-2 stores a second private key, a second public key, and a second secret key, and the third terminal 100-3 stores a third private key, a third public key, and a third secret key.

As an exemplary embodiment, when the service providing apparatus 200 receives a service performance request from the first terminal 100-1, the service providing apparatus 200 performs the authentication on the first terminal 100-1 based on the digital signature value generated by the first terminal 100-1. Specifically, when the service providing apparatus 200 receives the service performance request from the first terminal 100-1, the service providing apparatus 200 applies data corresponding to the requested service as an input value of a specific hash function to generate a hash value and transmits the generated hash value to the first terminal 100-1 to request the digital signature. At this time, data corresponding to the service may include information about a type of the service, cost information required for the service, and information about a service provider.

The first terminal 100-1 encrypts the hash value using the first private key to generate a first digital signature value and transmits the generated first digital signature value and the first public key to the service providing apparatus 200.

The service providing apparatus 200 requests the public key verification server 130 to verify the first public key received from the first terminal 100-1. When it is confirmed that the first public key is provided by the public key verification server 130 as a verification result, the service providing apparatus 200 decrypts the first digital signature value based on the first public key and verifies whether the decrypted value is equal to the hash value transmitted to the first terminal.

When the verification is completed, the service providing apparatus 200 may transmit a hash value which is the same as the hash value transmitted to the first terminal 100-1, to the second terminal 100-2 and the third terminal 100-3.

The second terminal 100-2 and the third terminal 100-3 may complete the authentication by the same method as the verification confirming method of the first terminal 100-1. However, it is not an essential process and may be omitted if necessary. That is, the second terminal 102-2->100-2 (third terminal 100-3) encrypts the hash value using the second private key (third private key) to generate a second digital signature value (third digital signature value) and transmits the generated second digital signature value (third digital signature value) and the second public key (third public key) to the service providing apparatus 200. The service providing apparatus 200 requests the public key verification server 130 to verify the second public key (third public key) received from the second terminal 100-2 (third terminal 100-3). When it is confirmed that the second public key (third public key) is provided by the public key verification server 130 as a verification result, the service providing apparatus 200 decrypts the second digital signature value (third digital signature value) based on the second public key (third public key) and verifies whether the decrypted value is equal to the hash value transmitted to the first terminal.

When the verification is completed, the service providing apparatus 200 requests the terminals to transmit the secret key. Each terminal transmits the secret key stored in the memory and a message indicating whether to consent performance of the service to the service providing apparatus 200.

Specifically, the first terminal 100-1 transmits the first secret key and a message indicating the consent to performance of the service to the service providing apparatus 200, the second terminal 100-2 transmits the second secret key and a message indicating the consent to performance of the service to the service providing apparatus 200, and the third terminal 100-3 transmits the third secret key and a message indicating whether to consent the performance of the service to the service providing apparatus 200. At this time, the first terminal 100-1 which requests the performance of the service first may not transmit the message indicating whether to consent the performance of the service.

The service providing apparatus 200 may identify whether the secret key received from each terminal is equal to a secret key stored in the memory. If the received secret key is equal to the stored secret key, the service providing apparatus 200 determines whether to perform the service based on the consent message received from each terminal.

As described above, if all the digital signature values received from the plurality of terminals 100-1 to 100-3 are verified, all the secret keys received from the plurality of terminals 100-1 to 100-3 are verified, and all the consent messages which is received from the plurality of terminals 100-1 to 100-3 indicate the consents to the performance of the service, the processor of the service providing apparatus 200 determines that the service performance condition is satisfied.

When the service performance condition is not satisfied, the processor of the service providing apparatus 200 may end the service without performing the requested service.

In contrast, when the service performance condition is satisfied, the processor of the service providing apparatus 200 calculates a first amount applied to the virtual account in accordance with the performance of the requested service and a second amount applied to each of actual accounts which are linked to the virtual account based on an ownership ratio of each of the plurality of holders for the virtual account and are individually owned by the plurality of holders 1 to 3 (S13).

Specifically, the processor of the service providing apparatus 200 may calculate the second amount by applying the ownership ratio to the first amount.

For example, when the ownership ratios of the plurality of holders 1 to 3 are 50%, 30%, and 20% and a service to remit 100000 won from the virtual account is requested, the processor of the service providing apparatus 200 confirms 100000 won as a first amount.

Thereafter, the processor of the service providing apparatus 200 applies an ownership ratio of 50% of the first holder 1 to 100000 won which is the first amount to calculate the second amount to be applied to the actual account of the first holder to be 50000 won, applies an ownership ratio of 30% of the second holder 2 to 100000 won which is the first amount to calculate the second amount to be applied to the actual account of the second holder to be 30000 won, and applies an ownership ratio of 20% of the third holder 2 to 100000 won which is the first amount to calculate the second amount to be applied to the actual account of the third holder to be 20000 won.

Finally, the processor of the service providing apparatus 200 applies the second amount to the actual account of each of the plurality of holders 1 to 3 to perform the requested service (S14).

Continuing the above-described exemplary embodiment, the processor of the service providing apparatus 200 remits 50000 won calculated as the second amount from the actual account of the first holder 1 to the requested account, remits 30000 won calculated as the second amount from the actual account of the second holder 2 to the requested account, and remits 20000 won calculated as the second amount from the actual account of the third holder 3 to the requested account to perform the requested service.

In the meantime, even though the first to third service performance conditions are not satisfied, if a simplified approval condition is satisfied, the processor of the service providing apparatus 200 according to another exemplary embodiment may perform the requested service.

Specifically, the processor of the service providing apparatus 200 determines whether the simplified approval condition is satisfied based on one or more of whether the first amount is less than a small amount and whether a consent message received from a terminal of a holder set as a simple approver among the plurality of holders indicates consent to performance of the service.

At this time, when the first amount is less than a small amount, the processor of the service providing apparatus 200 determines that the simplified approval condition is satisfied. Further, when the consent message received from the terminal of the holder set as a simple approver, among the plurality of holders, indicates the consent to the performance of the service, the processor of the service providing apparatus 200 determines that the simplified approval condition is satisfied.

Further, when the first amount is less than a small amount and the consent message received from the terminal of the holder set as a simple approver, among the plurality of holders, indicates the consent to the performance of the service, the processor of the service providing apparatus 200 determines that the simplified approval condition is satisfied.

Next, when it is determined that the simplified approval condition is satisfied, even though the service performance condition is not satisfied, the processor of the service providing apparatus 200 calculates the second amount to perform the service.

The processor of the service providing apparatus 200 performs a service performance request to remit the first amount which is a small amount without the consents of all the holders. Further, when a consent to the performance of the service is ensured from only a holder set as a representative simple approver, the processor of the service providing apparatus 200 may perform the service.

Here, the simple approver may be selected by the agreement of the plurality of holders 1 to n.

In the meantime, a communication unit of the service providing apparatus 200 according to another exemplary embodiment receives an ownership changing request to change the predetermined ownership ratio from any one of the plurality of terminals 100-1 to 100-n. Here, the ownership changing request includes changed ownership ratio information which is information about an ownership ratio requested to be changed.

At this time, when the ownership changing request is received, the processor of the service providing apparatus 200 transmits a pro/con message request requesting a pro/con message together with information regarding the changed ownership ratio to the plurality of terminals 100-1 to 100-n.

Next, when the pro/con messages indicating the approval of the change of the ownership ratio are received from all the plurality of terminals 100-1 to 100-n, as a response of the pro/con message request, the processor of the service providing apparatus 200 changes the predetermined ownership ratio to a change-requested ownership ratio.

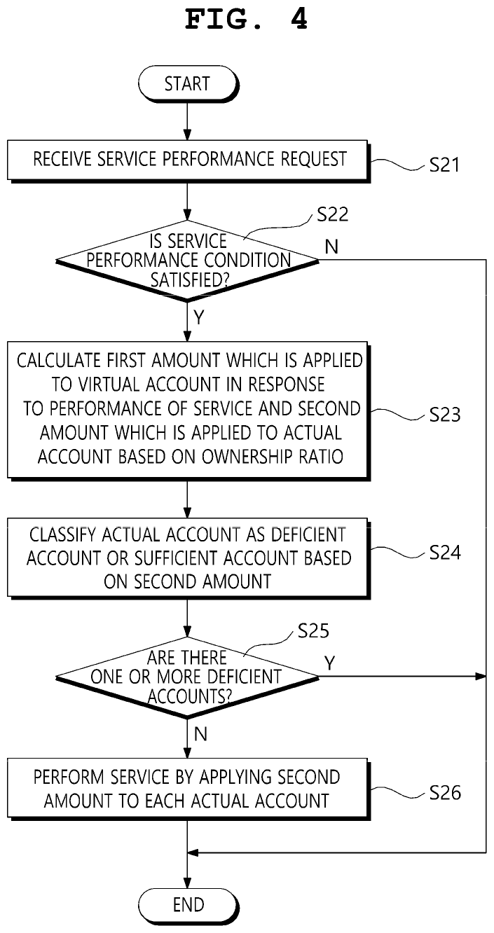

FIG. 4 is a flowchart illustrating a service providing method using a jointly owned virtual account according to another exemplary embodiment of the present disclosure.

Referring to FIG. 4, the communication unit of the service providing apparatus 200 receives a service performance request which requests the performance of the service using a virtual account which is jointly owned by the plurality of holders (S21).

Next, the processor of the service providing apparatus 200 may determine whether a service performance condition is currently satisfied (S22).

At this time, the processor of the service providing apparatus 200 determines whether the service performance condition is satisfied by the same process as a step S12 of the service providing method using a jointly owned virtual account according to the exemplary embodiment of the present disclosure.

When the service performance condition is not satisfied, the processor of the service providing apparatus 200 may end the service without performing the requested service.

In contrast, when the service performance condition is satisfied, the processor of the service providing apparatus 200 calculates a first amount applied to the virtual account in accordance with the performance of the requested service and a second amount applied to each of actual accounts which are linked to the virtual account based on an ownership ratio of each of the plurality of holders for the virtual account and are individually owned by the plurality of holders 1 to 3 (S23).

Specifically, the processor of the service providing apparatus 200 may calculates the second amount by applying the ownership ratio to the first amount.

Next, the processor of the service providing apparatus 200 classifies the actual accounts of the plurality of holders 1 to 3 to a deficient account or a sufficient account based on the calculated second amount (S24).

Specifically, the processor of the service providing apparatus 200 calculates an amount difference between a balance of the actual account of each of the plurality of holders 1 to 3 and the second amount and classifies an actual account whose amount difference is calculated to be less than a reference amount as a deficient account.

In contrast, the processor of the service providing apparatus 200 may classify the actual account whose amount difference is equal to or larger than the reference amount as a sufficient account.

For example, the ownership ratios of the plurality of holders 1 to 3 are 50%, 30%, and 20%, respectively, and a service requesting to remit 100000 won from the virtual account is requested and second amounts for the actual accounts of the plurality of holders 1 to 3 are calculated to be 50000 won, 30000 won, and 20000 won, the balances of the plurality of holders 1 to 3 are 40000 won, 80000 won, and 90000 won, and the reference amount is 0 won.

At this time, the processor of the service providing apparatus 100 calculates the amount differences corresponding to the actual accounts of the plurality of holders 1 to 3 to be −10000 won, 50000 won, and 70000 won, respectively and classifies the actual account of the first holder 1 having the amount difference which is less than the reference amount 0 as a deficient account. Further, the processor classifies the actual accounts of the second and third holders 2 and 3 having the amount difference which is equal to or larger than the reference amount 0 as sufficient accounts.

Next, the processor of the service providing apparatus 200 checks whether one or more accounts are classified as deficient accounts, among the actual accounts of the plurality of holders 1 to 3 (S25).

As the checking result, when one or more accounts are classified as deficient accounts, among the actual accounts of the plurality of holders 1 to 3, the processor of the service providing apparatus 200 may end the service without performing the requested service.

In contrast, when there is no account classified as a deficient account, among the actual accounts of the plurality of holders 1 to 3, the processor of the service providing apparatus 200 applies the second amount to the actual account of each of the plurality of holders 1 to 3 to perform the requested service (S26).

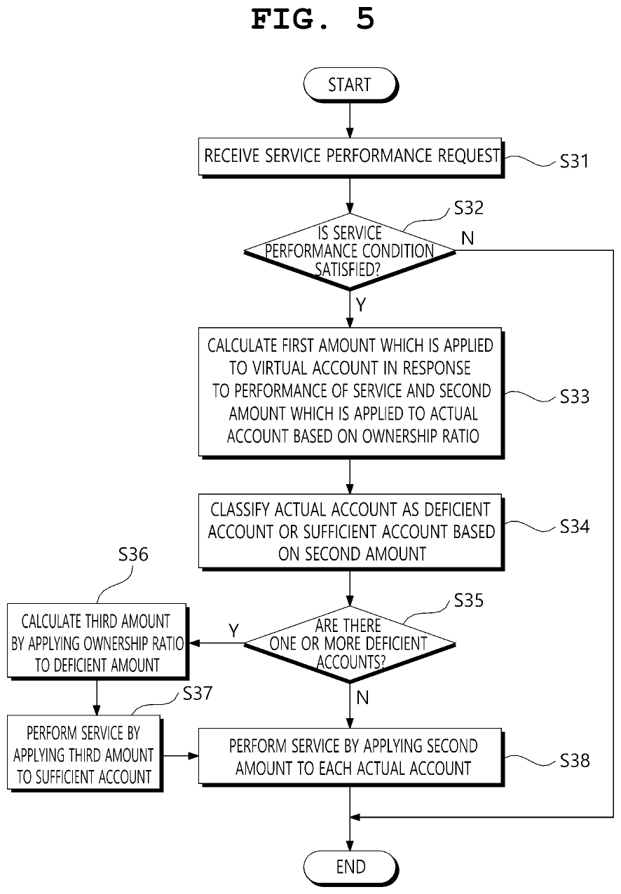

FIG. 5 is a flowchart illustrating a service providing method using a jointly owned virtual account according to still another exemplary embodiment of the present disclosure.

Referring to FIG. 5, the communication unit of the service providing apparatus 200 receives a service performance request which requests the performance of the service using a virtual account which is jointly owned by the plurality of holders (S31). Next, the processor of the service providing apparatus 200 may determine whether a service performance condition is currently satisfied (S32).

At this time, the processor of the service providing apparatus 200 determines whether the service performance condition is satisfied by the same process as a step S12 of the service providing method using a jointly owned virtual account according to the exemplary embodiment of the present disclosure.

When the service performance condition is not satisfied, the processor of the service providing apparatus 200 may end the process without performing the requested service.

In contrast, when the service performance condition is satisfied, the processor of the service providing apparatus 200 calculates a first amount applied to the virtual account in accordance with the performance of the requested service and a second amount applied to each of actual accounts which are linked to the virtual account based on an ownership ratio of each of the plurality of holders for the virtual account and are individually owned by the plurality of holders 1 to 3 (S33).

Specifically, the processor of the service providing apparatus 200 may calculates the second amount by applying the ownership ratio to the first amount.

Next, the processor of the service providing apparatus 200 classifies the actual accounts of the plurality of holders 1 to 3 to a deficient account or a sufficient account based on the calculated second amount (S34).

Specifically, the processor of the service providing apparatus 200 calculates an amount difference between a balance of the actual account of each of the plurality of holders 1 to 3 and the second amount and classifies an actual account whose amount difference is calculated to be less than a reference amount as a deficient account.

In contrast, the processor of the service providing apparatus 200 may classify the actual account whose amount difference is equal to or larger than the reference amount as a sufficient account.

Next, the processor of the service providing apparatus 200 checks whether one or more accounts are classified as deficient accounts, among the actual accounts of the plurality of holders 1 to 3 (S35).

As a checking result, when there is no account classified as a deficient account, among the actual accounts of the plurality of holders 1 to 3, the processor of the service providing apparatus 200 applies the second amount to the actual account of each of the plurality of holders 1 to 3 to perform the requested service (S38).

In contrast, when at least one account among the actual accounts of the plurality of holders 1 to 3 is classified as a deficient account, the processor of the service providing apparatus 200 adds amount differences which are less than the reference amount, among the calculated amount differences, to be calculated as a deficient account and applies a relative ratio between the ownership ratios of the holder of the sufficient account to the calculated deficient amount to calculate a third amount (S36).

Continuing the above-described example, the ownership ratios of the plurality of holders 1 to 3 are 50%, 30%, and 20%, respectively, and a service requesting to remit 100000 won from the virtual account is requested and second amounts for the actual accounts of the plurality of holders 1 to 3 are calculated to be 50000 won, 30000 won, and 20000 won, the balances of the plurality of holders 1 to 3 are 40000 won, 80000 won, and 90000 won, and the reference amount is 0 won.

At this time, the processor of the service providing apparatus 100 calculates the amount differences corresponding to the actual accounts of the plurality of holders 1 to 3 to be −10000 won, 50000 won, and 70000 won and classifies the actual account of the first holder 1 having the amount difference which is less than the reference amount 0 as a deficient account. Further, the processor classifies the actual accounts of the second and third holders 2 and 3 having the amount difference which is equal to or larger than the reference amount 0 as sufficient accounts.

Next, the processor of the service providing apparatus 200 calculates −10000 won as a deficient amount by adding the amount difference of −10000 won which is less than the reference amount, and applies relative ratios 60% (30%/(30%+20%)) and 30%(20%/(30%+20%)) between the ownership ratios of the second holder 2 and the third holder 3 of the sufficient accounts to the deficient amount of −10000 won to calculate 6000 won as a third amount to be applied to the actual account of the second holder 2 classified as a sufficient account and calculate 4000 won as a third amount to be applied to the actual account of the third holder 3 classified as a sufficient account.

Next, the processor of the service providing apparatus 200 performs the service by applying the third amount corresponding to the sufficient account to the sufficient account.

Continuing the above-described exemplary embodiment, the processor of the service providing apparatus 200 remits 6000 won which is calculated as the third amount from the actual account of the second holder 2 classified as a sufficient account to the requested account and remits 4000 won which is calculated as the third amount from the actual account of the third holder 3 classified as a sufficient account to the requested account to perform the requested service.

Finally, the processor of the service providing apparatus 200 applies the second amount to the actual account of each of the plurality of holders 1 to 3 to perform the requested service (S38).

In the meantime, after completing the service corresponding to the third amount and the second amount, when an amount which is equal to or larger than the amount difference is deposited in the actual account of the holder which is classified as a deficient account, the service providing apparatus 200 according to another exemplary embodiment may transfer an amount corresponding to the third amount deposited from the actual account of the holder classified as a sufficient account from the deficient account to the sufficient account.

When the third amount is transferred, the service providing apparatus 200 according to another exemplary embodiment of the present disclosure calculates a proxy transfer fee corresponding to the amount difference of the deficient account to set in each deficient account and when an amount which is equal to or larger than the proxy transfer fee is transferred to the deficient account, withdraws the amount corresponding to the proxy transfer fee from the deficient account.

At this time, the service providing apparatus 200 according to another exemplary embodiment applies the ownership ratio for the virtual account of the holder of the deficient account corresponding to the amount difference of the deficient account to calculate the proxy transfer fee.

For example, when the amount difference of the deficient account is −10000 won and the ownership ratio for the virtual account of the holder of the deficient account is 20%, the service providing apparatus 200 according to another exemplary embodiment calculates 2000 won calculated by multiplying −10000 won and −20% as the proxy transfer fee

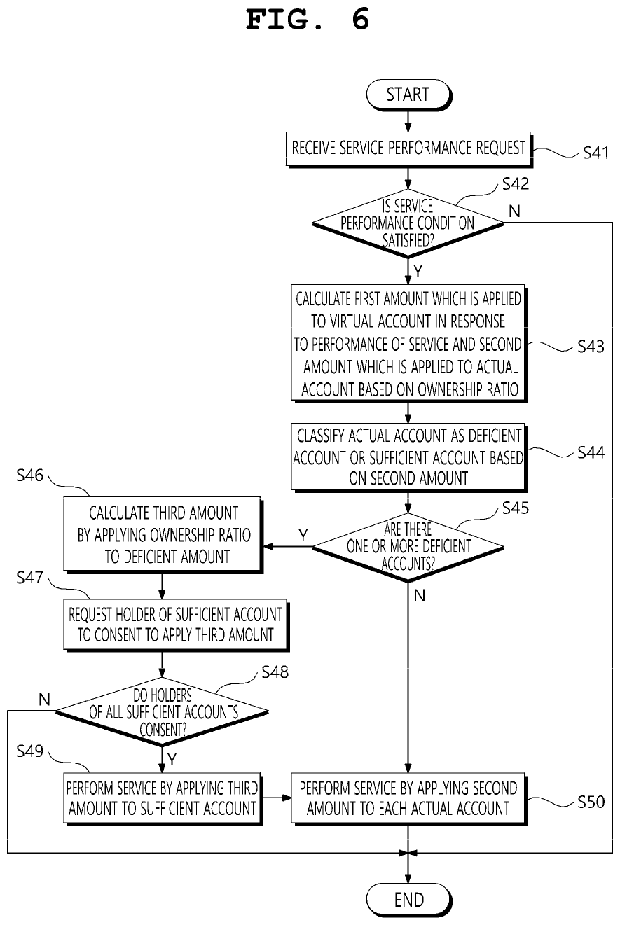

FIG. 6 is a flowchart illustrating a service providing method using a jointly owned virtual account according to still another exemplary embodiment of the present disclosure.

Referring to FIG. 6, the communication unit of the service providing apparatus 200 receives a service performance request which requests the performance of the service using a virtual account which is jointly owned by the plurality of holders (S41).

Next, a processor of the service providing apparatus 200 may determine whether a service performance condition is currently satisfied (S42).

At this time, the processor of the service providing apparatus 200 determines whether the service performance condition is satisfied by the same process as a step S12 of the service providing method using a jointly owned virtual account according to the exemplary embodiment of the present disclosure.

When the service performance condition is not satisfied, the processor of the service providing apparatus 200 may end the process without performing the requested service.

In contrast, when the service performance condition is satisfied, the processor of the service providing apparatus 200 calculates a first amount applied to the virtual account in accordance with the performance of the requested service and a second amount applied to each of actual accounts which are linked to the virtual account based on an ownership ratio of each of the plurality of holders for the virtual account and are individually owned by the plurality of holders (first to third) (S43).

Specifically, the processor of the service providing apparatus 200 may calculates the second amount by applying the ownership ratio to the first amount.

Next, the processor of the service providing apparatus 200 classifies the actual accounts of the plurality of holders (1 to 3) to a deficient account or a sufficient account based on the calculated second amount (S44).

Specifically, the processor of the service providing apparatus 200 calculates an amount difference between a balance of the actual account of each of the plurality of holders 1 to 3 and the second amount and classifies an actual account whose amount difference is calculated to be less than a reference amount as a deficient account.

In contrast, the processor of the service providing apparatus 200 may classify the actual account whose amount difference is equal to or larger than the reference amount as a sufficient account.

Next, the processor of the service providing apparatus 200 checks whether one or more accounts are classified as deficient accounts, among the actual accounts of the plurality of holders 1 to 3 (S45).

As a checking result, when there is no account classified as a deficient account, among the actual accounts of the plurality of holders 1 to 3, the processor of the service providing apparatus 200 applies the second amount to the actual account of each of the plurality of holders 1 to 3 to perform the requested service (S50).

In contrast, when one or more accounts among the actual accounts of the plurality of holders 1 to 3 are classified as deficient accounts, the processor of the service providing apparatus 200 adds the amount differences which are less than the reference amount, among the calculated amount differences to calculate as a deficient amount and applies the relative ratio between the ownership ratios of the holder of the sufficient account to the calculated deficient amount to calculate a third amount (S46).

Next, the processor of the service providing apparatus 200 asks the holder of the sufficient account for the consent to perform the service by applying the third amount to the sufficient account (S47).

For example, when the third amount applied to the actual account of the second holder 2 classified as the sufficient account is calculated as 6000 won and the third amount applied to the actual account of the third holder 3 classified as the sufficient account is calculated as 4000 won, the processor asks the second holder 2 for the consent to apply the third amount of 6000 won and asks the third holder 3 for the consent to apply the third amount of 4000 won.

As a result of asking for the consent, when all the holders of the sufficient accounts agree (Y in step S48), that is, when consent messages are received from the holders of all the sufficient accounts, the processor of the service providing apparatus 200 performs the service by applying the third amount corresponding to the sufficient account to the sufficient account (S49).

For example, when the consent messages are received from the second holder 2 and the third holder 3, the processor of the service providing apparatus 200 performs the requested service by remitting 6000 won calculated as the third amount from the actual account of the second holder 2 classified as a sufficient account to the requested account and remitting 4000 won calculated as the third amount from the actual account of the third holder 3 classified as a sufficient account to the requested account.

Next, the processor of the service providing apparatus 200 applies the second amount to the actual account of each of the plurality of holders 1 to 3 to perform the requested service (S50).

However, as the result of asking for the consent in step S47, if any one of holders of the sufficient accounts does not consent (N in step S48), the processor of the service providing apparatus 200 may end the service without performing the requested service.

Steps of the method or algorithm described in connection with the exemplary embodiment of the present disclosure may be directly implemented by hardware or implemented by a software module executed by the hardware or a combination thereof. The software module may reside on RAM (Random Access Memory), ROM (Read Only Memory), EPROM (Erasable Programmable ROM), EEPROM (Electrically Erasable Programmable ROM), a flash memory, a hard disk, a removable disk, a CD-ROM, or an arbitrary computer readable recording medium known in the art.

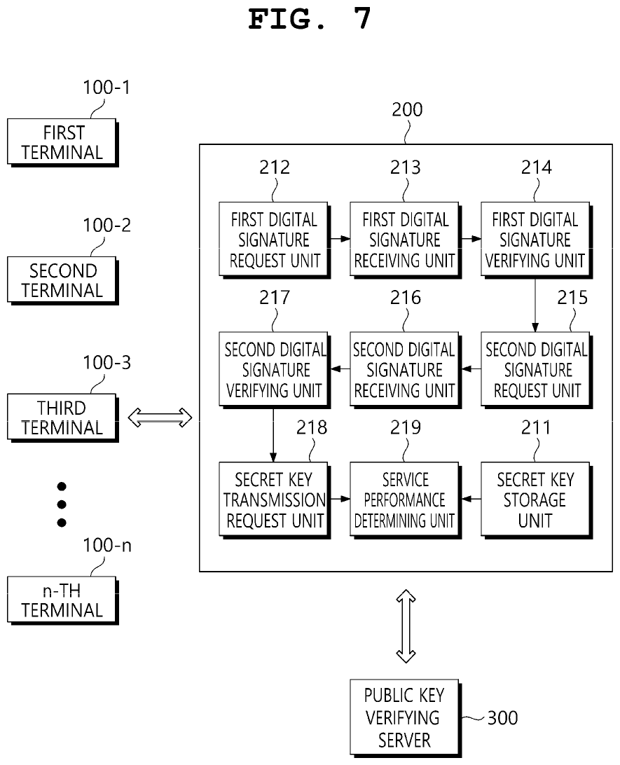

FIG. 7 is a block diagram illustrating a configuration of a service providing apparatus according to an exemplary embodiment of the present disclosure in detail.

Referring to FIG. 7, the service providing apparatus 200 includes a secret key storage unit 211, a first digital signature request unit 212, a first digital signature receiving unit 213, a first digital signature verifying unit 214, a second digital signature request unit 215, a second digital signature receiving unit 216, a second digital signature verifying unit 217, a secret key transmission request unit 218, and a service performance determining unit 219. Specifically, each configuration is stored in the memory in the form of a program to be operated by the processor.

The first digital signature request unit 212, the first digital signature receiving unit 213, and the first digital signature verifying unit 214 are configurations for verifying a digital signature value of a terminal which requests the performance of the service and the second digital signature request unit 215, the second digital signature receiving unit 216, and the second digital signature verifying unit 217 are configurations for verifying digital signature values of the remaining terminals. If necessary, the first digital signature request unit 212, the first digital signature receiving unit 213, the first digital signature verifying unit 214 and the second digital signature request unit 215, the second digital signature receiving unit 216, and the second digital signature verifying unit 217 may be configured by one digital signature request unit, one digital signature receiving unit, and one digital signature verifying unit or may be configured by a plurality of digital signature request units, a plurality of digital signature receiving units, and a plurality of digital signature verifying units corresponding to the individual terminals.

The secret key transmission request unit 218 is a configuration for requesting the plurality of terminals 100-1 to 100-3 to transmit the secret key when the verification of the digital signature value of the remaining terminal is completed. When a correct secret key is transmitted from the plurality of terminals 100-1 to 100-3, the service performance determining unit 219 determines whether the service performance condition is satisfied based on the contents of the consent message to perform the service which is transmitted by the plurality of terminals 100-1 to 100-3 together with the secret key. For example, when the plurality of terminals 100-1 to 100-3 transmits the consent message to perform the service, the service performance determining unit 219 determines whether the service performance condition is satisfied. As another example, some of the plurality of terminals 100-1 to 100-3 transmits the message of consent to perform the service and the others transmits no-consent message to perform the service, the service performance determining unit 219 determines that the service performance condition is not satisfied.

Components of the present disclosure is implemented as a program (or an application) to be coupled to a computer which is hardware to be executed and stored in a medium. Similar to execution of the components of the present disclosure with software programming or software elements, the exemplary embodiment may be implemented by programming or scripting languages such as C, C++, Java, assembler including various algorithms implemented by a combination of data structures, processes, routines, or other program configurations. The functional aspects may be implemented by an algorithm executed in one or more processors.

The exemplary embodiments of the present invention have been described with reference to the accompanying drawings, but those skilled in the art will understand that the present disclosure may be implemented in another specific form without changing the technical spirit or an essential feature thereof. Therefore, it should be understood that the above-described exemplary embodiments are illustrative in all aspects and do not limit the present disclosure.

1. A service providing apparatus using a jointly owned virtual account, comprising:
a communication unit which receives a service performance request which requests the performance of a service performed using a virtual account which is jointly owned by a plurality of holders; and
a processor which calculates a first amount which is applied to the virtual account in response to the performance of the service and a second amount which is applied to an actual account which is linked to the virtual account based on an ownership ratio of each of the plurality of holders and is individually owned by the plurality of holders,
wherein the processor performs the service by applying the second amount corresponding to the actual account to the actual account.

2. The service providing apparatus using a jointly owned virtual account according to claim 1, wherein the processor generates the virtual account based on account information of the actual account and ownership ratio information of each of the plurality of holders.

3. The service providing apparatus using a jointly owned virtual account according to claim 1, wherein the processor calculates the second amount by applying the ownership ratio to the first amount.

4. The service providing apparatus using a jointly owned virtual account according to claim 1, wherein the processor determines whether a service performance condition is satisfied, based on a digital signature value received from a terminal of each of the plurality of holders, a secret key received from the terminal of each of the plurality of holders, and a consent message which is received from the terminal of each of the plurality of holders and indicates whether the holder consents to perform the service.

5. The service providing apparatus using a jointly owned virtual account according to claim 4, wherein when it is determined that the service performance condition is satisfied, the processor performs the service by calculating the second amount.

6. The service providing apparatus using a jointly owned virtual account according to claim 4, wherein the processor determines whether a first service performance condition is satisfied based on a verification result of the digital signature value, determines whether a second service performance condition is satisfied based on a verification result of the secret key, and determines whether a third service performance condition is satisfied based on the consent message.

7. The service providing apparatus using a jointly owned virtual account according to claim 1, wherein the processor calculates an amount difference between a balance of the actual account and the second amount, classifies an actual account whose amount difference is calculated to be less than a reference amount as a deficient account, and when one or more actual accounts are classified as the deficient accounts, does not perform the service.

8. The service providing apparatus using a jointly owned virtual account according to claim 1, wherein the processor calculates an amount difference between a balance of the actual account and the second amount,
classifies an actual account whose amount difference is calculated to be less than a reference amount as a deficient account, and classifies an actual account whose amount difference is calculated to be equal to or larger than a reference amount as a sufficient account, adds amount differences which are less than the reference amount, among the amount differences, to be calculated as a deficient amount, applies the ownership ratio of a holder of the sufficient account to the deficient amount to calculate a third amount, and applies a third amount corresponding to the sufficient account to the sufficient account to perform the service.

9. The service providing apparatus using a jointly owned virtual account according to claim 1, wherein the processor calculates an amount difference between a balance of the actual account and the second amount, classifies an actual account whose amount difference is calculated to be less than a reference amount as a deficient account, and classifies an actual account whose amount difference is calculated to be equal to or larger than a reference amount as a sufficient account, adds amount differences which are less than the reference amount, among the amount differences, to be calculated as a deficient amount, applies the ownership ratio of a holder of the sufficient account to the deficient amount to calculate a third amount, and requests a holder of the sufficient account for the consent to apply the third amount to the sufficient account and when the consent messages are received from the holders of all the sufficient accounts, applies the third amount corresponding to the sufficient account to the sufficient account to perform the service.

10. The service providing apparatus using a jointly owned virtual account according to claim 8, wherein when an amount which is equal to or larger than the amount difference is deposited to an actual account classified as the deficient account, the processor transmits the third amount from an actual account classified as the deficient account to an actual account classified as the sufficient account.

11. The service providing apparatus using a jointly owned virtual account according to claim 5, wherein the processor determines whether the simplified approval condition is satisfied based on one or more of whether the first amount is less than a small amount and whether a consent message received from a terminal of a holder set as a simple approver among the plurality of holders indicates consent to performance of the service and when it is determined that the simple approval condition is satisfied, the processor performs the service by calculating the second amount even though the service performance condition is not satisfied.

12. The service providing apparatus using a jointly owned virtual account according to claim 1, wherein the processor changes the ownership ratio based on a pro/con message indicating approval/disapproval of the holder about the change of the ownership ratio.

13. A service providing method using a jointly owned virtual account, comprising:
receiving a service performance request which requests the performance of a service performed using a virtual account which is jointly owned by a plurality of holders, by a communication unit;
calculating a first amount which is applied to the virtual account in response to the performance of the service and a second amount which is applied to an actual account which is linked to the virtual account based on a relative ratio between ownership ratios of the plurality of holders and is individually owned by the plurality of holders by a processor; and
performing the service by applying the second amount corresponding to the actual account to the actual account, by the processor.

14. The service providing method using a jointly owned virtual account according to claim 13, further comprising:
generating the virtual account based on account information of the actual account and ownership ratio information of each of the plurality of holders, by the processor; and
calculating the second amount by applying the ownership ratio to the first amount, by the processor.

15. A computer program which is combined with a computer which is a hardware to be stored in a computer readable recording medium to perform the method according to claim 13.
